(19) United States
(12) Patent Application Publication
(10) Pub. No.: US 2009/0016486 A1
(43) Pub. Date: Jan. 15, 2009

(54) Nickel Flux Composition

(75) Inventor: David Brown, West Australia (AU)

Correspondence Address: BROOKS KUSHMAN P.C., 1000 TOWN CENTER, TWENTY-SECOND FLOOR, SOUTHFIELD, MI, 48075, US

(73) Assignee: X-RAY FLUX PTY LTD, Osborne PK, WA (AU)

(21) Appl. No.: 12/159,912

(22) PCT Filed: Jan. 27, 2006
(86) PCT No.: PCT/AU2006/000096

§ 371 Date: Jul. 2, 2008

(30) Foreign Application Priority Data
Jan. 5, 2006 (AU) 2006900048

(51) Int. Cl. G01N 23/223; G01N 37/00

(52) U.S. Cl. 378/42; 252/408.1

(57) ABSTRACT

In the x-ray fluorescence analysis of minerals, ores and other materials, chemicals containing lithium and boron are melted together at high temperatures to produce lithium borate compounds which are then cooled and reduced in size to a powder or coarse material. Such material is known as x-ray flux and is usually represented or specified in the final commercial product as ratios of lithium tetraborate to lithium metaborate. The x-ray flux is melted with materials to be analyzed and cast into discs which are then analyzed by an x-ray fluorescence spectrograph. In this invention, thulium has been added, mixed and melted with the x-ray flux such as to function as an internal quantitative standard for the analysis of nickel ore, nickel concentrates or other nickel containing substances, when such flux is mixed and melted with the nickel containing samples to be analyzed.

### FIELD OF THE INVENTION

This invention relates to the analysis of materials, and in particular to a flux composition for x-ray fluorescence spectroscopy analysis of nickel ore, nickel concentrates or other nickel containing substances.

### DESCRIPTION

Throughout the description, unless the context requires otherwise, the word “comprise” or variations such as “comprises” or “comprising”, will be understood to imply the inclusion of a stated integer or group of integers but not to the exclusion of any other integer or group of integers.

### BACKGROUND

X-ray flux is produced by fusing at high temperatures (approximately 1100 degrees C.) in platinum or platinum alloy crucibles, chemicals containing lithium and boron. The molten material is then cooled and reduced in size to a powder or coarse material. The resultant material is x-ray flux and is usually represented or specified in the final commercial product as ratios of lithium tetraborate to lithium metaborate.

The x-ray flux is then mixed with samples to be analyzed, e.g. nickel ore, nickel concentrates or other nickel containing substances and melted in a platinum or platinum alloy mold. Alternatively, the mixture is melted in a platinum or platinum alloy crucible and poured into a platinum or platinum alloy mold. The mold is cooled and the result is a glass like disc which is then placed into an x-ray fluorescence spectrograph machine for analysis.

### Previous Difficulties

Difficulties exist with the calibration of the x-ray fluorescence spectrograph to get accurate concentration of the target analyte nickel in the disc with confidence. In practice, external standards containing known amounts of nickel are used to calibrate the spectrograph. Such standards have in turn had to be analysed by classical wet chemistry techniques which involve extremely hazardous chemicals and which are very labour intensive (approximately 2 days per analysis). Such chemical analysis is not generally used for routine analysis because of time constraints. As nickel has increased in price dramatically over recent years any increase in accuracy for routine analysis of nickel and decrease in time for analysis (approximately 2 minutes for x-ray analysis) would mean significant economic advantages for nickel producers.

### Inventive Idea

The inventor has found that the rare earth element thulium, a specific element of the lanthanide group of elements, has hitherto unsuspected x-ray fluorescence properties such that when fused together with lithium and boron compounds to form x-ray flux, it is useful as an internal standard for the accurate quantitative determination of nickel in nickel ore, nickel concentrates or nickel containing substances when such ore, concentrates or substances are fused with the x-ray flux. Thus in accordance with this aspect of the invention there is presented an x-ray fluorescence flux composition for the accurate quantitative determination of nickel in nickel ore, nickel concentrates or nickel containing substances, having an ionic moiety of thulium.

It has been found that thulium has an x-ray fluorescence wavelength close to nickel, such that the matrix or interference effect is effectively the same as for nickel. Further the thulium and nickel spectral lines are similarly affected by the other elements usually present in nickel ore, nickel concentrates or other nickel containing substances samples. Consequently, by examining the ratios of the intensity of the wavelength of thulium to nickel, the amount of nickel in the fused disc and subsequently in the sample, can be easily and accurately determined mathematically. Furthermore, the nickel flux composition provides a failsafe analytical technique, in that should the spectral lines for thulium not be present, the analysis can be considered to have failed, also if the thulium spectral lines are not present at the known intensity then the spectrograph could be considered to have been subject to electronic instability and drift and therefore not able to give accurate results until realigned or repaired.

### BEST MODE(S) FOR CARRYING OUT THE INVENTION

The embodiment involves the addition of thulium or thulium containing compounds to the lithium and boron containing chemicals before fusing to make the flux. The addition of thulium or thulium compounds is added such that the percentage of thulium in the finished flux is from 0.01 to 25% by weight.

Sodium nitrate, lithium nitrate, or other oxidizing compounds, can also be also added to the lithium, boron and thulium containing compounds after fusing to give a percentage of sodium nitrate, lithium nitrate, or other oxidizing compounds, in the finished flux of 1 to 25% by weight. Sodium nitrate, lithium nitrate, or other oxidizing compounds are added if required, to oxidize sulphides when they are present in the nickel ore, nickel concentrates or other nickel containing substances, so they can be analysed.

A batch of flux is made up by adding to 99.5 grams of lithium tetraborate and lithium metaborate in the proportion of 1.2 parts to 2.2 parts respectively or a mixture of chemicals which when fused gives the equivalent of fusing the directly aforementioned mixture, 0.5 grams of thulium oxide (Tm₂O₃). These ingredients are combined and mixed, and placed in a platinum or platinum alloy crucible and are fused at 1100 degrees C. The fused mix, which forms a liquid glass, is allowed to cool and reduced in size to a coarse material or a powder to produce the finished flux composition.

In use, a known quantity of nickel ore, nickel concentrates or other nickel containing substances is combined with a known quantity of the finished flux composition, such that the amount of nickel ore, nickel concentrates or other nickel containing substances relative to the amount of elemental thulium present in the flux composition is known. This mixture is melted at high temperature. Typically from 1:4 to 1:30 by weight ratio nickel ore, nickel concentrates or other nickel containing substances to flux is usually satisfactory, depending upon the nickel ore, nickel concentrates or nickel containing substances type and grade. For typical nickel ore deposits in Western Australia, which are usually of about 0.5% nickel grade, 1 gram of ore is added to 7 grams of flux containing a percentage of sodium nitrate, and melted in a platinum or platinum alloy mold. For nickel concentrates containing about 25% nickel about 0.36 g of nickel concentrates is added to about 9 grams of flux containing a percentage of sodium nitrate, and melted in a platinum or platinum alloy mold. Alternatively, the nickel ore, nickel concentrates or nickel containing substances and flux is melted in a platinum or platinum alloy crucible and poured into a mold. The mold is cooled, the contents forming a glass-like disc which is then placed into an x-ray fluorescence spectrograph machine for analysis. The amount of nickel present is determined by analysis of the spectral lines and comparison with the spectral lines of thulium.

1. A flux composition comprising lithium values and boron values as a borate of lithium, together with thulium such that the ionic moiety of thulium is present in proportion of at least 0.01% by weight of boron values in said composition and such flux being specifically used for the quantitative determination of nickel in nickel ore, nickel concentrates, or nickel containing substances by x-ray fluorescence spectrography.

2. The flux composition of claim 1 where the ionic moiety of thulium is present in proportion of at least 0.1% by weight of boron values in the said composition.

3. The flux composition of claim 1 where the ionic moiety of thulium is present in proportion of at least 1.0% by weight of boron values in the said composition.

4. The flux composition of claim 1 where the ionic moiety of thulium is present in proportion of at least 5.0% by weight of boron values in the said composition.

5. The flux composition of claim 1 where the ionic moiety of thulium is present in proportion of at least 10.0% by weight of boron values in the said composition.

6. The flux composition of claim 1 where the ionic moiety of thulium is present in proportion of at least 20.0% by weight of boron values in the said composition.

7. The flux composition of claim 1 where the ionic moiety of thulium is present in proportion of at least 30.0% by weight of boron values in the said composition.

8. The flux composition of claim 1 where the ionic moiety of thulium is present in proportion of 1.5% to 4.0% by weight of boron values in the said composition.

9. The flux composition of claim 1 where the ionic moiety of thulium is present in proportion of about 1.9% by weight of boron values in the said composition.

10. The flux composition of claim 1 where the borate of lithium may be entirely lithium tetraborate.

11. The flux composition of claim 1 where the borate of lithium may be entirely lithium meta-borate.

12. The flux composition of claim 1 where the borate of lithium comprises a mixture of lithium tetraborate and lithium meta-borate in a range of proportions from 1:10 to 10:1.

13. The flux composition of claim 1 where the borate of lithium comprises a mixture of lithium tetraborate and lithium meta-borate in the proportion of 1.2:2.2 respectively.

14. The flux composition of claim 1 where the lithium may be provided from any lithium containing compound and the boron may be provided from any boron containing compound.

15. The flux composition of claim 1 where the thulium may be provided from any thulium containing compound.

16. The flux composition of claim 1 comprises finely divided particles of a fusion of compounds.

17. A known quantity of the flux compositions of claim 1 is mixed and fused with a predetermined sample of nickel ore, nickel concentrates or other nickel containing substances, and an x-ray fluorescence spectroscopy is performed on the said fusion.

18. The said ore and said flux composition of claim 17 are mixed in weight proportion from 1:1 to 1:50.

19. The said ore and said flux composition of claim 1 is mixed in weight proportion between 1% and 50% respectively.
